(19) United States
(12) Patent Application Publication
(10) Pub. No.: US 2017/0277629 A1
(43) Pub. Date: Sep. 28, 2017

(54) EXTENDING THE USEFUL LIFESPAN OF NONVOLATILE MEMORY

(71) Applicant: Alibaba Group Holding Limited, Grand Cayman (KY)

(72) Inventor: Shu LI, San Jose, CA (US)

(21) Appl. No.: 15/081,512

(22) Filed: Mar. 25, 2016

(51) Int. Cl. G06F 12/02

(52) U.S. Cl. CPC G06F 12/0246

(57) ABSTRACT

A system for extending the useful lifespan of solid-state nonvolatile memory includes a memory that stores machine instructions and a processor coupled to the memory that executes the machine instructions to reconfigure a unit of nonvolatile memory cells from a first configuration that stores a minimum state, one of a group of intermediate states, or a maximum state as a current state to a second configuration that stores the minimum state, one of a subset of the group of intermediate states, or the maximum state as the current state.

### TECHNICAL FIELD

The present disclosure relates generally to nonvolatile memory and, more particularly, to extending the useful lifespan of solid-state flash memory cells.

### BACKGROUND

Solid-state flash memory is used to implement nonvolatile memory in many relatively high-performance computer systems, including, for example, data center servers. In general, these systems are periodically replaced with newer, higher-capacity models. In some cases, the lifespan of each generation of hardware can be shorter than desirable, potentially requiring significant repeated investment in hardware resources.

Some memory components, such as NAND flash memory-based solid-state drives (SSD), conventionally retain significant residual life at the point in time that the server platforms are retired. For example, a server with a three-year warranty may implement component SSDs that have a five-year warranty. This can result in regular disposal of SSDs that could otherwise provide continued use.

Typically, before NAND flash memory cells can be programmed, the cells must first be erased to remove excess electrons from the memory cell floating gate. During programming, electrons migrate from the semiconductor substrate to the floating gate. In practice, repeated program/erase (P/E) operations can cause the NAND flash memory cells to gradually deteriorate. As a result, as NAND flash memory cells age the bit error rate (BER) in retrieved data can eventually reach an unacceptably high error rate.

This effect generally is more pronounced in NAND flash memory cells that store more than one bit of information, such as multi-level cell (MLC) and triple-level cell (TLC) technologies that store two or three bits per cell, respectively. In order to be capable of storing a larger number of states, these cells require additional threshold (Vₜₕ) voltage levels distributed over a similar voltage range with respect to single-level cell (SLC) technology. Thus, the gap or margin between levels is reduced in MLC and TLC cells, typically resulting in a relative increase in erroneous readings with respect to SLC cells.

### SUMMARY

According to one embodiment of the present invention, a system for extending the useful lifespan of nonvolatile memory includes a memory that stores machine instructions and a processor coupled to the memory that executes the machine instructions to reconfigure a unit of nonvolatile memory cells from a first configuration that stores one current state selected from the group consisting of a minimum state, at least one intermediate state, and a maximum state to a second configuration that stores one current state selected from the group consisting of the minimum state and the maximum state.

According to another embodiment of the present invention, a computer-implemented method of extending the useful lifespan of nonvolatile memory includes reconfiguring a unit of nonvolatile memory cells from a first configuration that stores one current state selected from the group consisting of a minimum state, at least one intermediate state, and a maximum state to a second configuration that stores one current state selected from the group consisting of the minimum state and the maximum state.

According to yet another embodiment of the present invention, a computer program product for extending the useful lifespan of nonvolatile memory includes a non-transitory, computer-readable storage medium encoded with instructions adapted to be executed by a processor to implement reconfiguring a unit of nonvolatile memory cells from a first configuration that stores one current state selected from the group consisting of a minimum state, at least one intermediate state, and a maximum state to a second configuration that stores one current state selected from the group consisting of the minimum state and the maximum state and reassigning a discrete value associated with the maximum state.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a block diagram illustrating an exemplary nonvolatile memory (NVM) system in accordance with an embodiment of the present invention.

FIG. 2 is an exemplary graph plotting probability density against NAND flash memory block program/erase (P/E) cycles in accordance with an embodiment of the present invention.

FIG. 3 illustrates an exemplary multi-level cell (MLC) threshold voltage distribution diagram, as well as an exemplary reconfigured MLC threshold voltage distribution diagram in accordance with an embodiment of the present invention.

FIG. 4 illustrates an exemplary triple-level cell (TLC) threshold voltage distribution diagram, as well as a pair of exemplary reconfigured TLC threshold voltage distribution diagrams in accordance with an embodiment of the present invention.

FIG. 5 is a flowchart representing an exemplary method of extending the useful lifespan of nonvolatile memory in accordance with an embodiment of the present invention.

### DETAILED DESCRIPTION

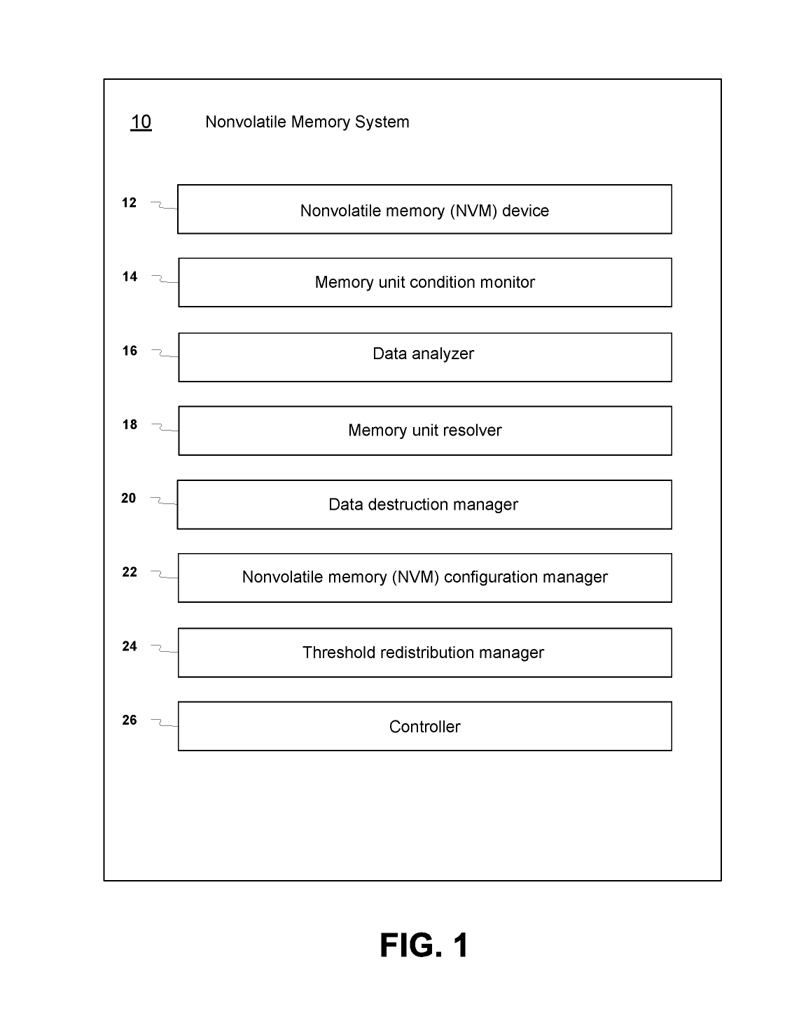

An embodiment of the present invention is shown in FIG. 1, which illustrates an exemplary nonvolatile memory (NVM) system 10 that employs a memory block monitoring and reconfiguration process in order to extend the useful lifespan of solid-state flash memory. The NVM system 10 includes a nonvolatile memory (NVM) device 12, a memory unit condition monitor 14, a data analyzer 16, a memory unit resolver 18, a data destruction manager 20, a nonvolatile memory (NVM) configuration manager 22, and a threshold redistribution manager 24 and a controller 26.

The NVM device 12 includes a solid-state memory device, such as a solid-state drive (SSD) implementing NAND flash memory or NOR flash memory. The NVM system 10 can extend the useful lifespan of the NVM device 12. For example, the NVM system 10 can recapture the remaining life of a previously-implemented NVM device 12 in its original configuration. In addition, the NVM system 10 can prolong the life of an NVM device 12 implementing memory cells that store more than two states or more than one bit of information, such as multi-level cell (MLC) or triple-level cell (TLC) solid-state flash memory, by reconfiguring the threshold voltage (Vₜₕ) distribution of flash memory cells. In some embodiments, reconfiguring the threshold voltage distribution increases the gap or noise margin between the states or levels used determine the meaning or value of information stored in the memory cells and, thus, decreases the bit error rate (BER) caused by noise crossover between the states or levels.

In various embodiments, the overall lifespan of a NAND flash memory-based NVM device 12 in the NVM system 10 is considered to consist of three life stages. The first stage may include a period during which the NVM device 12 is initially installed as part of a system or device assembly with an initial expected life. For example, in an embodiment, a newly-manufactured NVM device 12 may be installed in a network server covered by an original equipment manufacturer (OEM) warranty period based on a statistically-predicted mean endurance of the various components assembled into the server.

The second stage may include a period during which the NVM device 12, while essentially remaining in its original form, is modified for continued use beyond the expected life of the system or device in which the NVM device 12 was originally installed. For example, in an embodiment, at the end of the OEM warranty period the network server may be disassembled and the NVM device 12 may be removed and implemented in another system or device in a sort of second life. For example, the component warranty period provided by the NVM device manufacturer may be longer than the OEM warranty covering the original server assembly. The second stage can reclaim the remaining expected life of the component NVM device 12 after the server has been retired from service.

The third stage may include a period during which some or all of the solid-state flash memory cells in the NVM device 12 are reconfigured to store fewer states or bits of information in each cell. For example, in an embodiment, multi-level cell (MLC) NAND flash memory cells are reconfigured to store two states (or a single bit of information) instead of four states (or two bits of information). In another embodiment, triple-level cell (TLC) NAND flash memory cells are reconfigured a first time to store four states (or two bits of information) instead of eight states (or three bits of information). In yet another embodiment, TLC NAND flash memory cells are reconfigured a second time to store two states (or a single bit of information).

The memory unit condition monitor 14 examines the health condition of discrete units of nonvolatile memory cells in the NVM system 10. In various embodiments, the memory unit condition monitor 14 monitors running conditions of individual NVM device units during all phases, including, for example, the amount of data written to the unit over time, estimated unit write amplification, program/erase (P/E) operation cycle statistics, and the like. In addition to collecting information for use in maintaining relatively even usage of NAND flash memory units through wear leveling techniques, the memory unit condition monitor 14 continuously or intermittently updates information regarding the wear condition, usability and space usage associated with the discrete units of solid-state flash memory cells in the NVM system 10.

In an embodiment, the unit of solid-state flash memory cells corresponds to a physical block of memory cells in the NVM device 12. Other embodiments may be based on another unit size. For example, as known in the art, a conventional SSD divides solid-state flash memory cells into logical units, or logical unit numbers (LUNs). Each LUN in turn includes a number of planes composed of multiple blocks, which are divided into pages. Typically, the page is the basic unit for program (write) and read operations. On the other hand, the block typically is the basic unit for erase operations.

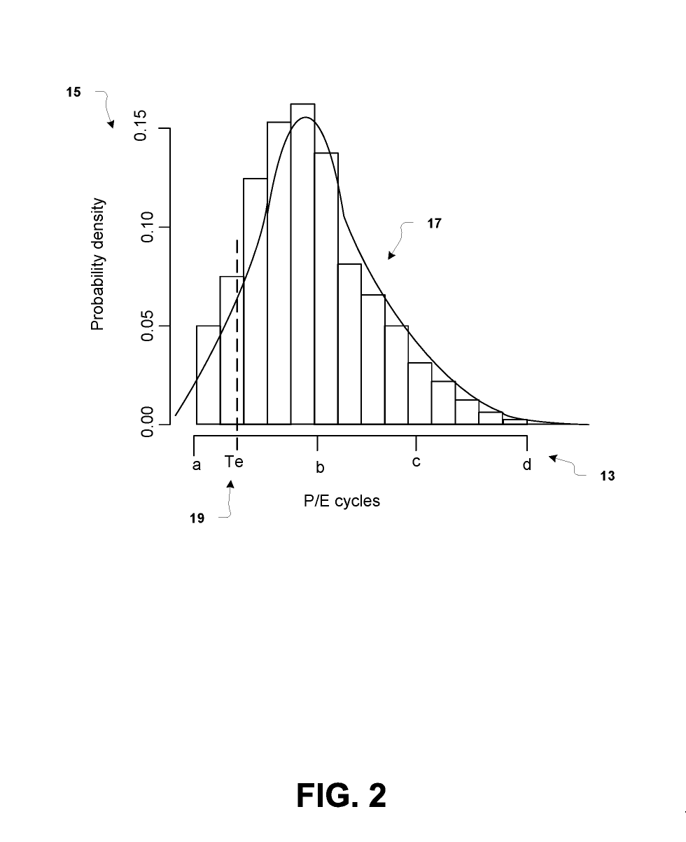

Over time, the memory unit condition monitor 14 accumulates program/erase cycle data. In practical applications, the accumulated number of P/E cycles for each unit of NAND flash memory cells varies in accordance with a statistical distribution, or probability density function. As shown in FIG. 2, in an embodiment, the memory unit condition monitor 14 plots P/E cycles 13 versus probability density 15 to yield a P/E cycle distribution. A usage expectation threshold value (Tₑ) 19 is determined as the nominal P/E cycle expectation, or endurance, of the NVM device 12.

The NAND blocks are graded based on online data analysis and, according to the resulting grade or score with respect to the usage expectation threshold value, selected blocks are used for the residual life as MLC or configured as SLC with enlarged noise margin. The NVM system 10 does not presume that all units of solid-state flash memory cells in an NVM device 12 share the same initial health condition. Instead of testing memory cells only at an initial point in time, the memory unit condition monitor 14 performs relatively fine-grained monitoring of memory cell conditions throughout the entire running period of each NVM device 12.

The data analyzer 16 analyzes each of the NVM units to determine a grade regarding the unit condition and to place the units in categories according to their condition. For example, the data analyzer 16 sorts the NVM units 12 categories based on the wear level of the individual NVM units 12.

The memory unit resolver 18 applies customized criteria to select those NVM devices 12 that may continue in use. For example, in an embodiment, at the point in time that a network server is retired from service, the component NVM devices 12 are directly scanned to make a decision regarding whether or not each component NVM device 12 may continue in use.

The data destruction manager 20 fully eliminates any existing content stored in each NVM device 12 that is qualified for reuse. All stored data is fully destroyed to ensure none of the previous data can be read out during reuse of the NVM device 12. In an embodiment, this operation is realized without erasing all blocks in order to avoid unnecessarily sacrificing additional P/E cycles. Only after the existing content has been eliminated may the NVM devices 12 be removed from the servers, or removed from the data center, and later reinstalled in another system or device.

The nonvolatile memory (NVM) configuration manager 22 modifies the NVM devices 12 that have been selected for continued use to adapt the selected NVM devices 12 for use in other systems or devices in the second phase. The NVM configuration manager 22 resets one or more NVM device 12 constraints to allow the remaining life of the NVM device 12 to be recovered after the network server has been retired.

Based on unit-by-unit information that has been collected regarding the NAND flash memory condition, the NVM configuration manager 22 adaptively modifies the usage expectation threshold (Tₑ) for each NVM device 12. In an embodiment, the NVM configuration manager 22 changes NVM device 12 settings by overriding the values stored in programmable registers. These settings are selected in accordance with the NAND flash memory condition information to balance the remaining NVM device 12 lifespan, operational efforts, performance and required capacity.

The threshold redistribution manager 24 reconfigures multiple-bit memory cells, such as multi-level cell (MLC) or triple-level cell (TLC) NAND flash memory, by reconfiguring the threshold voltage distribution of the flash memory cells. In general, after a programming sequence has been performed, the voltage range of an MLC memory cell is divided into four levels, or states, which are separated by three read voltage levels so the MLC memory cell can store two bits of information. Similarly, the voltage range of a TLC memory cell is divided into eight levels, which are separated by seven read voltage levels, so the TLC memory cell can store three bits of information.

In either case, the width of the gaps, or margins, between the voltage levels affects the error rate. As the NAND flash memory cells deteriorate with an increased number of P/E cycles, the individual voltage level distributions widen, causing the margins to become more narrow over time. Eventually, the voltage level distributions may begin to overlap, resulting in an increased error rate.

The threshold redistribution manager 24 reconfigures units of flash memory cells to store fewer states or bits of information in each cell. In doing so, the gap or noise margin between the threshold voltage distributions of the two states widens, which is designed to effectively counteract the memory cell capability degradation. In various embodiments, the expanded noise margin ensures the required NVM device 12 performance despite the accumulated wear.

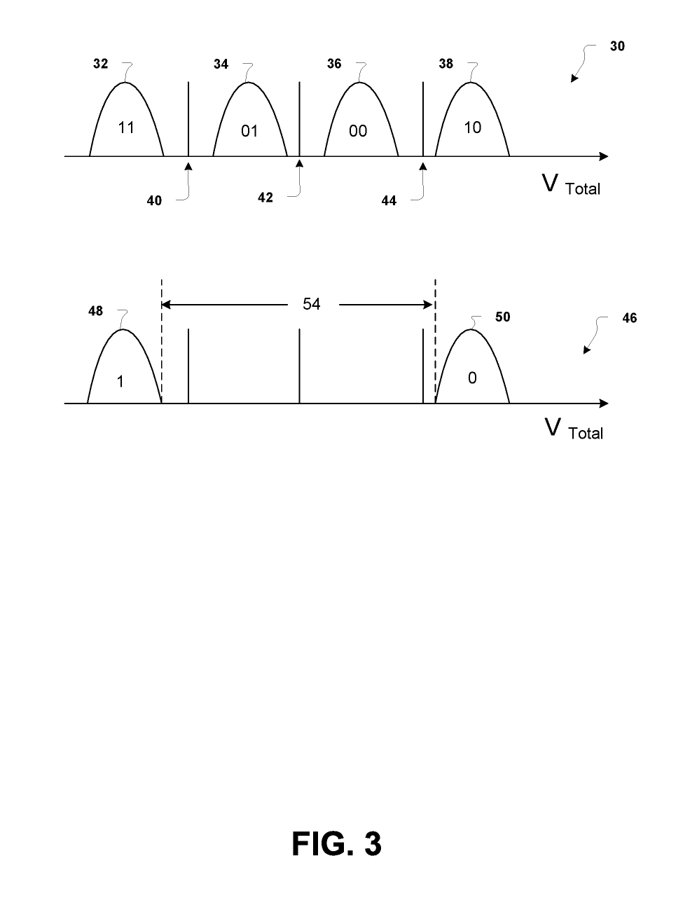

For example, in an embodiment, the threshold redistribution manager 24 reconfigures a unit of MLC NAND flash memory cells to store a single bit of information instead of two bits of information in each cell. Referring now to FIG. 3, an exemplary MLC threshold voltage distribution diagram 30 with four programmable states or levels 32, 34, 36, 38 separated by three read voltage levels 40, 42, 44 is shown. The MLC threshold voltage distribution diagram 30 also illustrates an exemplary reconfigured MLC threshold voltage distribution diagram 46 with two programmable states or levels 48, 50.

Before reconfiguration, the standard MLC memory cell stores one of four states or levels, including a minimum threshold voltage distribution 32, a first intermediate threshold voltage distribution 34, a second intermediate threshold voltage distribution 36, and a maximum threshold voltage distribution 38. After reconfiguration the MLC memory cell is programmed using only the leftmost state 48 (erased state, or minimum voltage level) and the rightmost state 50 (or maximum voltage level), which correspond to the minimum threshold voltage distribution 32 and the maximum threshold voltage distribution 38 of the MLC threshold voltage distribution diagram 30, respectively. The noise margin between the two levels is effectively increased to the approximate distance 54 between the minimum threshold voltage distribution 48 and the maximum threshold voltage distribution 50 of the standard MLC threshold voltage distribution diagram 46.

In practice, MLC memory cells generally are programmed to one of the four states or levels 32, 34, 36, 38 of the MLC threshold voltage distribution diagram 30 using a two-step programming procedure, in which a least significant bit (LSB) programming step that transitions from the erased state to a temporary interim state is followed by a most significant bit (MSB) programming step that transitions from the interim state to the target MLC state. In an embodiment, the reconfigured MLC memory cell is programmed from the erased state 48 to the maximum state 50 of the reconfigured MLC threshold voltage distribution diagram 46 using a one-step procedure that directly programs the maximum state 50 from the erased state 48.

During a read operation, increasing read voltage levels 40, 42, 44 of a standard MLC memory cell generally are checked to determine the current state stored in the memory cell. For example, if the threshold voltage is determined to be equal to or greater than the lowest read voltage level 40 but not equal to or greater than the next read voltage level 42, the second state 34 is indicated.

In an embodiment, when the threshold voltage level of the reconfigured MLC memory cell is determined to be equal to or greater than the lower read voltage level 40, the maximum state 50 is indicated. In another embodiment, when the threshold voltage level of the reconfigured MLC memory cell is determined to be equal to or greater than the median read voltage level 42, the maximum state 50 is indicated. In yet another embodiment, only when the threshold voltage level of the reconfigured MLC memory cell is determined to be equal to or greater than the upper read voltage level 44, the maximum state 50 is indicated.

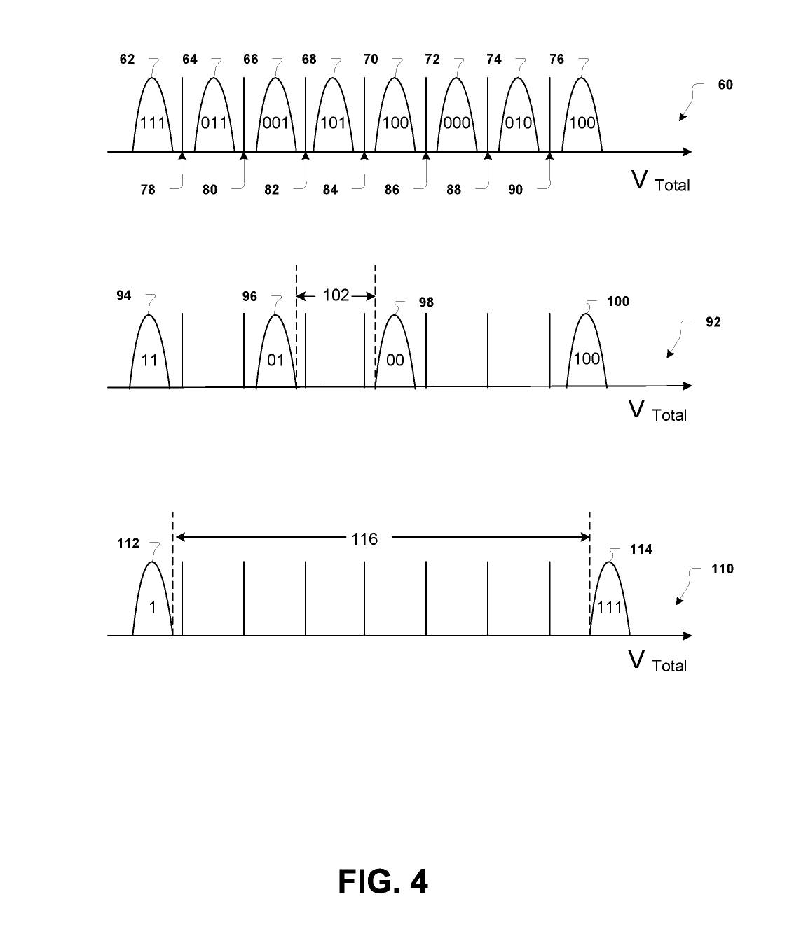

In another embodiment, the threshold redistribution manager 24 reconfigures a unit of TLC NAND flash memory cells to store two bits of information instead of three bits of information in each cell. Referring to FIG. 4, an exemplary TLC threshold voltage distribution diagram 60 with eight programmable states or levels 62, 64, 66, 68, 70, 72, 74, 76 separated by seven read voltage levels 78, 80, 82, 84, 86, 88, 90. FIG. 4 also illustrates an exemplary reconfigured TLC threshold voltage distribution diagram 92 with four programmable states or levels 94, 96, 98, 100.

Thus, after reconfiguration the TLC memory cell is programmed using only the erased state (or minimum threshold voltage level 94), the third state (or third TLC threshold voltage level 96), the fifth state (or fifth TLC threshold voltage level 98), and the seventh state (or seventh TLC threshold voltage level 100). The noise margin between the levels is effectively increased to the approximate distance 102 between consecutive TLC threshold voltage distributions.

In practice, TLC memory cells generally are programmed to one of the eight states or levels 62, 64, 66, 68, 70, 72, 74, 76 of the TLC threshold voltage distribution diagram 60 using a two-step programming procedure, in which a least significant bit (LSB) programming step is followed by a most significant bit (MSB) programming step. In an embodiment, the reconfigured TLC memory cell is programmed to one of the four states or levels 94, 96, 98, 100 of the reconfigured TLC threshold voltage distribution diagram 92 using a modified two-step procedure, in which a modified least significant bit (LSB) programming step that transitions from the erased state to an interim state is followed by a modified most significant bit (MSB) programming step that transitions from the interim state to the target state.

In yet another embodiment, the threshold redistribution manager 24 reconfigures the unit of TLC NAND flash memory cells a second time to store a single bit of information instead of two bits of information in each cell. Referring again to FIG. 4, another exemplary reconfigured TLC threshold voltage distribution diagram 110 with two programmable states or levels 112, 114.

Thus, after the second reconfiguration the TLC memory cell is programmed using only the erased state (or minimum threshold voltage level 112) and the maximum state (or maximum threshold voltage level 114). The noise margin between the two levels is effectively increased to the approximate distance 116 between the minimum threshold voltage distribution 112 and the maximum threshold voltage distribution 114 of the reconfigured TLC threshold voltage distribution diagram 110.

In an embodiment, the reconfigured TLC memory cell is programmed to one of the two states or levels 112, 114 of the reconfigured TLC threshold voltage distribution diagram 110 using a one-step procedure that directly programs the maximum level 114 from the erase level 112.

The controller 26 can execute programming code, such as source code, object code or executable code, stored on a computer-readable medium, such as the NVM device 12 or a peripheral storage component coupled to the NVM system 10, in order to perform the functions of the NVM system 10. In an embodiment, the NVM system 10 is implemented at the solid-state device (SSD) level, and functions of the NVM system 10 are implemented by the SSD flash translation layer (FTL). In some embodiments, the NVM system 10 is further coupled to a communication network by way of a network interface.

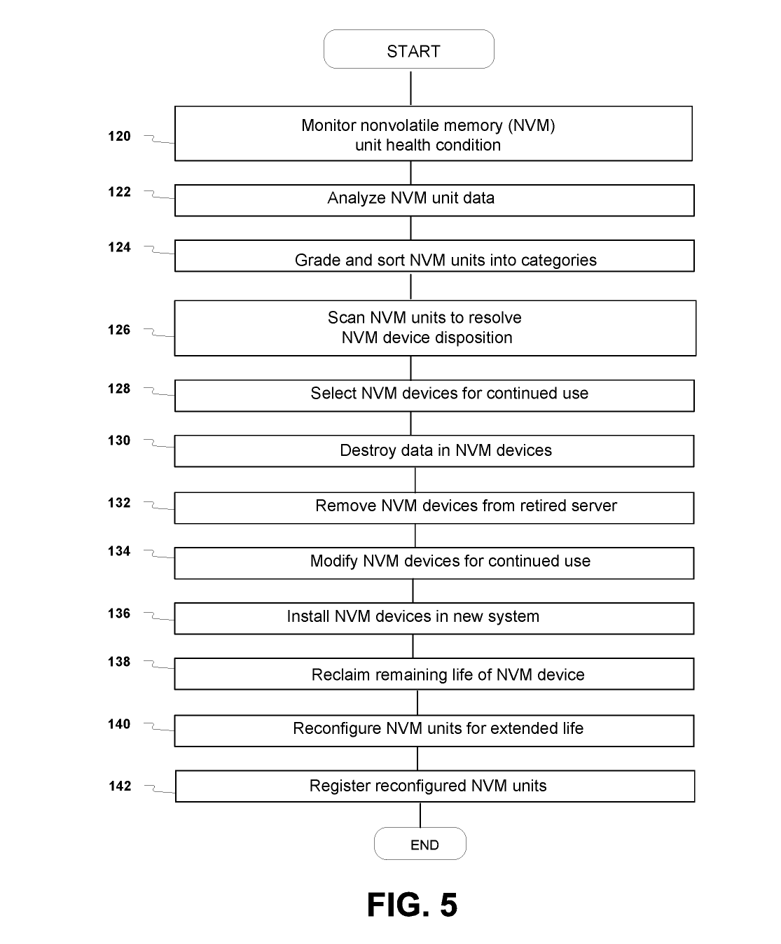

Referring now to FIG. 5, an exemplary process flow is illustrated that may be performed, for example, by the nonvolatile memory (NVM) system of FIG. 1 to implement an embodiment of the method described in this disclosure for extending the useful lifespan of solid-state nonvolatile memory. The process begins at block 120, where nonvolatile memory (NVM) units, such as planes, block or pages, are scanned over time during service to monitor the health condition of the individual NVM units, as described above. This condition monitoring occurs at a level of finer granularity with respect to conventional existing systems.

In block 122, the collected NVM unit health condition data is analyzed, for example, to update the wear condition of each unit, record bad or unusable blocks, and track unit space usage. The NVM units are individually graded and sorted into separate categories, in block 124, based on the health condition and expected remaining life of each NVM unit.

In block 126, at or near the end of life of original equipment, for example, a server or memory appliance, in which nonvolatile memory (NVM) devices such as NAND flash solid-state drives (SSDs) or other flash memory devices are installed, the NVM devices are scanned to resolve the disposition of the NVM devices. For example, in an embodiment, the number of NVM units assigned to various condition categories is evaluated to estimate the remaining expected life of the NVM devices.

NVM devices meeting certain customized criteria are selected, in block 128, for continued use in another service application after the original equipment has been retired, as explained above. In block 130, before the NVM devices are uninstalled from the original equipment, the data stored in the NVM devices is completely eliminated or destroyed, as described above.

In block 132, the selected NVM devices are removed from the original equipment being retired. The NVM devices are modified for continued use in another service application, in block 134. For example, settings in the NVM devices are changed to optimize the NVM devices for use in another system or appliance, as described above. In block 136, the NVM devices are installed in another system or appliance and, in block 138, the remaining expected life of the NVM devices is reclaimed through continued use in another service application.

In block 140, NVM units in the NVM devices are reconfigured to further extend the life of the NVM devices. As described above, the NVM units are reconfigured from a multiple-bit-per-cell configuration to a single-bit-per-cell configuration. For example, a state or threshold voltage distribution is reassigned a different discrete value. The reconfiguration procedure increases the noise margin between threshold voltage distributions for NVM memory cells to allow usage extension beyond the original expected life of the NVM devices. In block 142, the reconfigured NVM units are registered for tracking, for example, by a flash translation layer of the NVM device.

The systems and methods described herein can offer advantages such as increased noise margin between the threshold voltage levels used to determine the meaning or value of information stored in the memory cells. The corresponding decreased error rate caused by noise crossover between states can extend the useful life and reduce the total cost of ownership of solid-state drives (SSDs).

Aspects of this disclosure are described herein with reference to flowchart illustrations or block diagrams, in which each block or any combination of blocks can be implemented by computer program instructions. The instructions may be provided to a processor of a general purpose computer, special purpose computer, or other programmable data processing apparatus to effectuate a machine or article of manufacture, and when executed by the processor the instructions create means for implementing the functions, acts or events specified in each block or combination of blocks in the diagrams.

In this regard, each block in the flowchart or block diagrams may correspond to a module, segment, or portion of code that includes one or more executable instructions for implementing the specified logical function(s). It should also be noted that, in some alternative implementations, the functionality associated with any block may occur out of the order noted in the figures. For example, two blocks shown in succession may, in fact, be executed substantially concurrently, or blocks may sometimes be executed in reverse order.

A person of ordinary skill in the art will appreciate that aspects of this disclosure may be embodied as a device, system, method or computer program product. Accordingly, aspects of this disclosure, generally referred to herein as circuits, modules, components or systems, or the like, may be embodied in hardware, in software (including source code, object code, assembly code, machine code, micro-code, resident software, firmware, etc.), or in any combination of software and hardware, including computer program products embodied in a computer-readable medium having computer-readable program code embodied thereon.

It will be understood that various modifications may be made. For example, useful results still could be achieved if steps of the disclosed techniques were performed in a different order, and/or if components in the disclosed systems were combined in a different manner and/or replaced or supplemented by other components. Accordingly, other implementations are within the scope of the following claims.

What is claimed is:

1. A system for extending the useful lifespan of nonvolatile memory, comprising:
a memory that stores machine instructions; and
a processor coupled to the memory that executes the machine instructions to reconfigure a unit of nonvolatile memory cells from a first configuration that stores one current state selected from the group consisting of a first number of states to a second configuration that stores one current state selected from the group consisting of a second number of states, wherein the first number is larger than the second number.

2. The system of claim 1, wherein the processor further executes the machine instructions to reconfigure the unit from the first configuration that stores one current state selected from the group consisting of a minimum state, at least one intermediate state, and a maximum state to the second configuration that stores one current state selected from the group consisting of the minimum state and the maximum state.

3. The system of claim 2, wherein the minimum state corresponds to a minimum threshold voltage distribution and the maximum state corresponds to a maximum threshold voltage distribution, the minimum threshold voltage distribution and the maximum threshold voltage distribution corresponding to one selected from the group consisting of multi-level cell NAND flash memory or triple-level cell NAND flash memory.

4. The system of claim 1, wherein the processor further executes the machine instructions to register the unit of nonvolatile memory cells as a reconfigured unit in a flash translation layer, the unit of nonvolatile memory cells including a block of NAND flash memory cells in a solid-state drive.

5. The system of claim 1, wherein the processor further executes the machine instructions to register the unit of nonvolatile memory cells as a reconfigured unit in a flash translation layer.

6. The system of claim 1, wherein the processor further executes the machine instructions to monitor a condition associated with the unit of nonvolatile memory cells and select a solid-state drive including the unit of nonvolatile memory cells for continued use based the condition.

7. A method of extending the useful lifespan of nonvolatile memory, comprising:
reconfiguring a unit of nonvolatile memory cells from a first configuration that stores one current state selected from the group consisting of a first number of states to a second configuration that stores one current state selected from the group consisting of a second number of states, wherein the first number is larger than the second number.

8. The method of claim 7, wherein before the reconfiguring a threshold voltage associated with a memory cell of the unit of nonvolatile memory cells reading greater than a first predetermined voltage but less than a second predetermined voltage indicates a first intermediate state and after the reconfiguring the threshold voltage reading less than the second predetermined voltage indicates a minimum state.

9. The method of claim 7, wherein before the reconfiguring a threshold voltage associated with a memory cell of the unit of nonvolatile memory cells reading greater than a first predetermined voltage but less than a second predetermined voltage indicates a first intermediate state and after the reconfiguring the threshold voltage reading greater than the first predetermined voltage indicates a maximum state.

10. The method of claim 7, wherein reconfiguring the unit of nonvolatile memory cells further comprises reconfiguring the unit from the first configuration that stores one current state selected from the group consisting of a minimum state, a first intermediate state, a second intermediate state, and a maximum state to the second configuration.

11. The method of claim 7, wherein reconfiguring the unit of nonvolatile memory cells further comprises reconfiguring the unit from a third configuration that stores one current state selected from the group consisting of a minimum state, a first intermediate state, a second intermediate state, a third intermediate state, a fourth intermediate state, a fifth intermediate state, a sixth intermediate state, and a maximum state to the first configuration that stores one current state selected from the group consisting of the minimum state, a first intermediate state, a second intermediate state, and the maximum state.

12. The method of claim 7, wherein a minimum state corresponds to a minimum threshold voltage distribution and a maximum state corresponds to a maximum threshold voltage distribution.

13. The method of claim 12, wherein the first number of states correspond to one selected from the group consisting of multi-level cell NAND flash memory or triple-level cell NAND flash memory.

14. The method of claim 7, wherein reconfiguring the unit of nonvolatile memory cells further comprises disregarding at least one intermediate state.

15. The method of claim 7, wherein the reconfiguring a unit of nonvolatile memory cells further comprises reassigning a discrete value associated with a maximum state.

16. The method of claim 7, wherein a minimum state corresponds to an erased state.

17. The method of claim 16, further comprising programming a maximum state from the erased state after the reconfiguring in a single step.

18. The method of claim 7, wherein the unit of nonvolatile memory cells includes a block of NAND flash memory cells in a solid-state drive.

19. The method of claim 7, further comprising:
monitoring a condition associated with the unit of nonvolatile memory cells; and
selecting a solid-state drive including the unit of nonvolatile memory cells for continued use based the condition.

20. A computer program product for extending the useful lifespan of nonvolatile memory, comprising:
a non-transitory, computer-readable storage medium encoded with instructions adapted to be executed by a processor to implement:
reconfiguring a unit of nonvolatile memory cells from a first configuration that stores one current state selected from the group consisting of a first number of states to a second configuration that stores one current state selected from the group consisting of a second number of states wherein the first number is larger than the second number.
